(19) United States
(12) Patent Application Publication
(10) Pub. No.: US 2015/0369930 A1
(43) Pub. Date: Dec. 24, 2015

(54) RADIOGRAPHIC IMAGING DETECTOR USING VOLTAGE CONVERSION ON GLASS

(71) Applicant: CARESTREAM HEALTH, INC., Rochester, NY (US)

(72) Inventors: Ravi K. Mruthyunjaya, Penfield, NY (US); Jeffrey R. Hawver, Marion, NY (US)

(21) Appl. No.: 14/653,441

(22) PCT Filed: Mar. 14, 2014
(86) PCT No.: PCT/US14/27862

§ 371 Date: Jun. 18, 2015

Related U.S. Application Data
(60) Provisional application No. 61/790,618, filed on Mar. 15, 2013.

(51) Int. Cl. G01T 1/20; G01T 1/24

(52) U.S. Cl. CPC G01T 1/2018; G01T 1/247

(57) ABSTRACT

Exemplary embodiments of digital radiographic area detectors and/or methods for using the same can include an imaging array (12) including a plurality of active pixels (22), each active pixel (22) including at least one amorphous silicon and/or amorphous indium-gallium-zinc-oxide electrically chargeable photosensor and at least three thin-film transistors; scanlines coupled to a plurality of active pixels (22) arranged along a first direction in a portion of the imaging array (12); datalines coupled to a plurality of active pixels (22) arranged along a second direction in the portion of the imaging array (12); circuits to provide signal sensing for the portion of the imaging array (12) coupled to the second conductive lines; and charge conversion circuitry to convert voltage values output by the active pixels (22) to a corresponding charge values for input to the signal sensing circuits during readout.

### FIELD OF THE INVENTION

The invention relates generally to the field of medical imaging, and in particular to radiographic imaging and digital radiographic (DR) detectors and more particularly to amorphous silicon or polycrystalline radiographic detector arrays.

### BACKGROUND

There is a need for improvements in the consistency and/or quality of medical x-ray images, particularly when obtained by an x-ray apparatus designed to operate with a-Si DR x-ray detectors.

### SUMMARY OF THE INVENTION

An aspect of this application is to advance the art of medical digital radiography.

Another aspect of this application to address in whole or in part, at least the foregoing and other deficiencies in the related art.

It is another aspect of this application to provide in whole or in part, at least the advantages described herein.

An aspect of this application to is to provide methods and/or apparatus to address and/or reduce disadvantages caused by the use of portable (e.g., wireless) digital radiography (DR) detectors and/or radiography imaging apparatus using the same.

An aspect of this application to is to provide methods and/or apparatus that can provide active pixels in amorphous or polycrystalline semiconductor DR x-ray detectors.

In accordance with one embodiment, the present invention can provide a digital radiographic area detector that can include an imaging array including a plurality of active pixels, each active pixel including at least one polycrystalline or amorphous silicon electrically chargeable photosensor and thin-film transistors; a bias control circuit to provide a bias voltage to the photosensors for a portion of the imaging array; first conductive lines (e.g., scanlines) coupled to a plurality of active pixels arranged along a first direction in the portion of the imaging array; second conductive lines (e.g., datalines) coupled to a plurality of active pixels arranged along a first direction in the portion of the imaging array; circuits to provide signal sensing for the portion of the imaging array coupled to the second conductive lines; and charge conversion circuitry to convert voltage values output by the active pixels to a corresponding charge values for input to the signal sensing circuits. In one embodiment, the imaging array includes a-IGZO devices.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings.

The elements of the drawings are not necessarily to scale relative to each other.

FIG. 1 is a diagram that shows a perspective view of a radiographic imaging apparatus including an area detector according to the present application as composed of rows and columns of detector cells in position to receive x-rays passing through a patient during a radiographic procedure.

FIG. 2 is a diagram that shows cross-section of a related art digital radiographic detector.

FIG. 3 is a diagram that shows schematic of a portion of a related art imaging array for a radiographic detector.

FIG. 4 is a diagram that shows schematic of a portion of a related art imaging array including a passive pixel design with charge input ROIC for a radiographic detector.

FIG. 5 is a diagram that shows a schematic of a portion of an imaging array including an exemplary active pixel with voltage accepting ROIC embodiment according to the application.

FIG. 6 is a diagram that shows a schematic of a portion of an imaging array including an exemplary active pixel with voltage to charge conversion implemented on glass and charge input ROIC embodiment according to the application.

FIG. 7 is a diagram that shows a schematic of a portion of an imaging array including an exemplary active pixel with voltage to charge conversion implemented on ROIC embodiment according to the application.

### DESCRIPTION OF EXEMPLARY EMBODIMENTS

The following is a description of exemplary embodiments of the invention, reference being made to the drawings in which the same reference numerals identify the same elements of structure in each of the several figures.

Where they are used, the terms “first”, “second”, and so on, do not necessarily denote any ordinal or priority relation, but may be used for more clearly distinguishing one element or time interval from another.

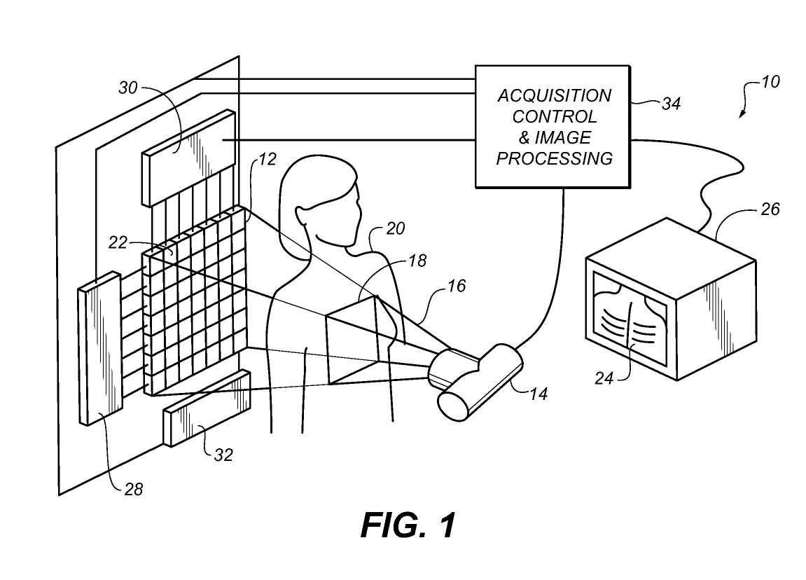

FIG. 1 is a diagram that shows a perspective view of an area detector according to the present application as composed of rows and columns of detector cells in position to receive x-rays passing through a patient during a radiographic procedure. As shown in FIG. 1, an x-ray system 10 that can use an area array 12 can include an x-ray tube 14 collimated to provide an area x-ray beam 16 passing through an area 18 of a patient 20. The beam 16 can be attenuated along its many rays by the internal structure of the patient 20 to then be received by the detector array 12 that can extend generally over a prescribed area (e.g., a plane) perpendicular to the central ray of the x-ray beam 16.

The array 12 can be divided into a plurality of individual cells 22 that can be arranged rectilinearly in columns and rows. As will be understood to those of ordinary skill in the art, the orientation of the columns and rows is arbitrary, however, for clarity of description it will be assumed that the rows extend horizontally and the columns extend vertically.

In exemplary operations, the rows of cells 22 can be scanned one (or more) at a time by scanning circuit 28 so that exposure data from each cell 22 may be read by read-out circuit 30. Each cell 22 can independently measure an intensity of radiation received at its surface and thus the exposure data read-out provides one pixel of information in an image 24 to be displayed on a monitor 26 normally viewed by the user. A bias circuit 32 can control a bias voltage to the cells 22.

Each of the bias circuit 32, the scanning circuit 28, and the read-out circuit 30, can communicate with an acquisition control and image processing circuit 34 that can coordinate operations of the circuits 30, 28 and 32, for example, by use of an electronic processor (not shown). The acquisition control and image processing circuit 34, can also control the examination procedure, and the x-ray tube 14, turning it on and off and controlling the tube current and thus the fluence of x-rays in beam 16 and/or the tube voltage and hence the energy of the x-rays in beam 16.

The acquisition control and image processing circuit 34 can provide image data to the monitor 26, based on the exposure data provided by each cell 22. Alternatively, acquisition control and image processing circuit 34 can manipulate the image data, store raw or processed image data (e.g., at a local or remotely located memory) or export the image data.

Exemplary pixels 22 can include a photo-activated image sensing element and a switching element for reading a signal from the image-sensing element. Image sensing can be performed by direct detection, in which case the image-sensing element directly absorbs the X-rays and converts them into charge carriers. However, in most commercial digital radiography systems, indirect detection is used, in which an intermediate scintillator element converts the X-rays to visible-light photons that can then be sensed by a light-sensitive image-sensing element.

Examples of image sensing elements used in image sensing arrays 12 include various types of photoelectric conversion devices (e.g., photosensors) such as photodiodes (P-N or PIN diodes), photo-capacitors (MIS), photo-transistors or photoconductors. Examples of switching elements used for signal read-out include MOS transistors, bipolar transistors and p-n junction components.

There are numerous types of x-ray equipment and configurations designed for specific radiographic procedures that can use area detectors. These can include wall-stand, floor-mount, chest, table units or mobile units; designed for supine, upright, or other patient orientations.

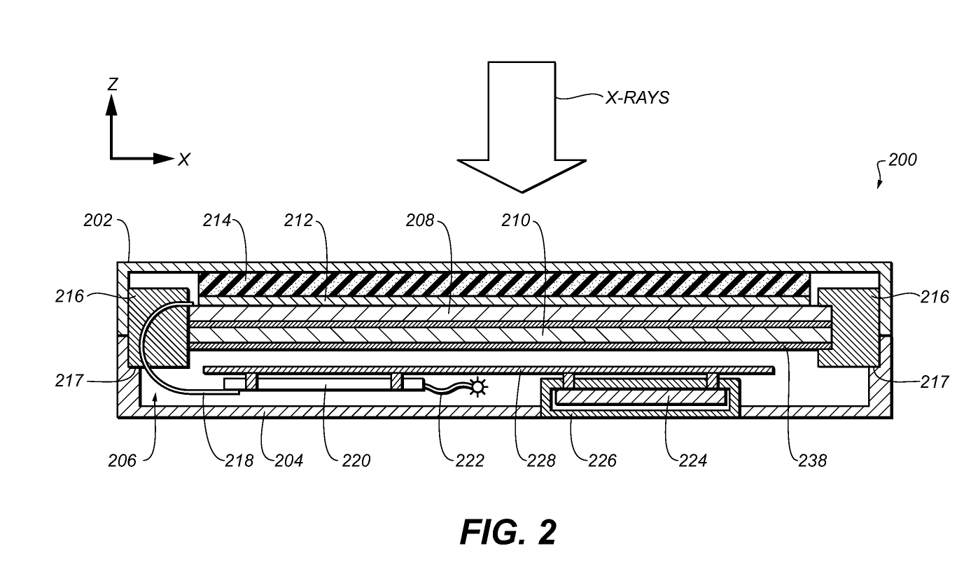

A related art area detector is shown in FIG. 2. As shown, DR area detector 200 includes upper housing 202, lower housing 204, secured together and forming a cavity 206. Mounted within cavity 206 are detector array 208 mounted on stiffener 210, screen (scintillator) 212, compliant foam member 214, lead shield 238, elastomer shock-absorbing supports 216 mounted on stop ledges 217 of lower housing 206, flex circuits 218 connected between detector array 208 and electronics 220. A wireless interface 222 is connected to electronics 220. A battery pack 224 is mounted in a compartment 226 of lower housing 204. Battery pack 224 and electronics 220 are thermally coupled to sheet metal member 228, which acts as a heat sink for heat generated by battery pack 224 and electronics 220. X-rays are projected to detector 200 in the direction of arrow A.

The embodiment of FIG. 2 has the scintillator screen 212 placed in contact with detector array 208 by means of compliant foam member 214, which applies and maintains this physical contact. Physical contact between screen 212 and detector array 208 can also be applied by means such as a spring or a plurality of springs. Further, an index-matching type optical adhesive could be used to bond screen 212 directly to detector array 208, so that compliant foam member is not needed.

To comply with ISO 4090.2001(E) standard, packaging of the detector array and supporting electronics becomes very challenging. There is limited space for these components in all directions (X, Y, Z). First, flex circuits connecting the detector array and electronics need to be wrapped underneath the array. Second, use of a self-contained battery and battery pack within the DR detector is preferred. In order to comply with the 16 mm cassette thickness, the self-contained battery and battery pack needs to be extremely thin. It is noted that the present invention is not limited to a self-contained battery, but could be energized through an external power source detector array. For durability reasons, the detector array 208 is attached to a stiffener 210 in an embodiment of the present invention. The stiffener is made of a lightweight composite that has similar thermal coefficient of expansion to the substrate material, but significantly higher bending stiffness than the substrate.

As shown in FIG. 2, the ROICs and electronics are shielded from x-ray s by lead shield 238, but are connected by flex circuits 218 to the sensor on glass/detector array 208.

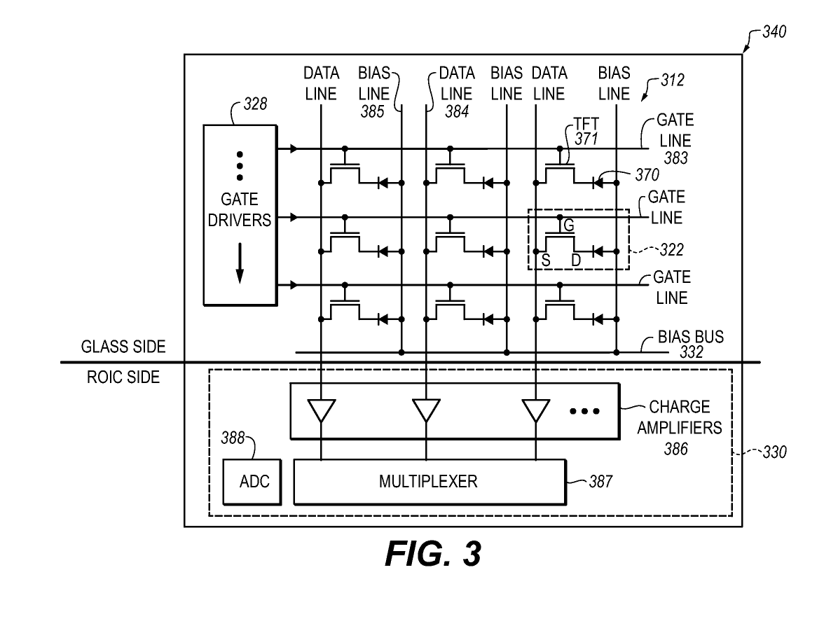

FIG. 3 is a diagram that shows a schematic of a portion of an related art imaging array for a radiographic detector. As shown in FIG. 3, a schematic of a portion of an exemplary flat panel imager 340 can include an array 312 having a number of a-Si:H n-i-p photodiodes 370 and TFTs 371. Gate driver chips 328 can connect to the blocks of gate lines 383, readout chips 330 can connect to blocks of data lines 384, and bias lines 385 can connect to a bias bus or variable bias reference voltage. Charge amplifiers 386 can be provided that receive signals from the data lines. An output from the charge amplifiers 386 can go to an analog multiplexer 387 or directly to an analog-to-digital converter (ADC) 388 to stream out the digital image data at desired rates.

In a hydrogenated amorphous silicon (a-Si:H) based indirect flat panel imager of FIG. 3, incident X-ray photons are converted to optical photons, which are subsequently converted to electron-hole pairs within the a-Si:H n-i-p photodiodes 370. The pixel charge capacity of the photodiodes is a product of the bias voltage and the photodiode capacitance. In general, a reverse bias voltage is applied to the bias lines 385 to create an electric field (and hence a depletion region) across the photodiodes and enhance charge collection efficiency. The image signal can be integrated by the photodiodes while the associated TFTs 371 are held in a non-conducting (“off”) state, for example, by maintaining the gate lines 383 at a negative voltage. The array can be read out by sequentially switching rows of the TFTs 371 to a conducting state by means of TFT gate control circuitry. When a row of pixels is switched to a conducting (“on”) state, for example by applying a positive voltage to the corresponding gate line 383, charge from those pixels can be transferred along data lines 384 and integrated by external charge-sensitive amplifiers 386. The row can then be switched back to a non-conducting state, and the process is repeated for each row until the entire array has been read out. The signal outputs from the external charge-sensitive amplifiers 386 are transferred to an analog-to-digital converter (ADC) 388 by a parallel-to-serial multiplexer 287, subsequently yielding a digital image. The flat panel imager having an imaging array as described with reference to FIG. 2 is capable of both single-shot (e.g., static, radiographic) and continuous (e.g., fluoroscopic) image acquisition.

Device electronics required for proper operation of the detector can be mounted within the cavity 206 and can include electronic components 220 (e.g., processors, FPGAs, ASICs, chips, etc.) that can be mounted on one or more separate and/or interconnected circuit boards 226.

This application describes various exemplary radiographic detector architectures and their glass interface (e.g., imaging array) to external Readout IC's (ROICs).

Architectures/embodiments described herein include: 1) traditional passive pixel design (related art), 2) voltage accepting ROIC, 3) V to Q (Voltage to Charge) conversion on glass, and 4) V to Q (Voltage to Charge) conversion on ROICs.

Certain exemplary embodiments described herein include, but are not limited to radiographic detector architectures and their glass interface to external Readout IC's (ROICs).

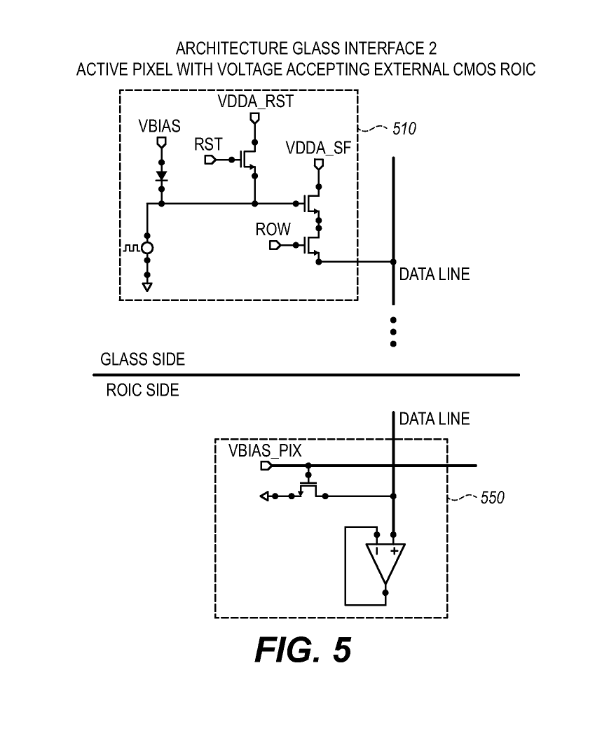

FIG. 5 is a diagram that shows an imaging array with a glass side active pixel design with voltage output in combination with a ROIC embodiment that accepts voltage according to the application. The embodiment shown in FIG. 5 can use a new novel ROIC design rather than a traditional charge input design.

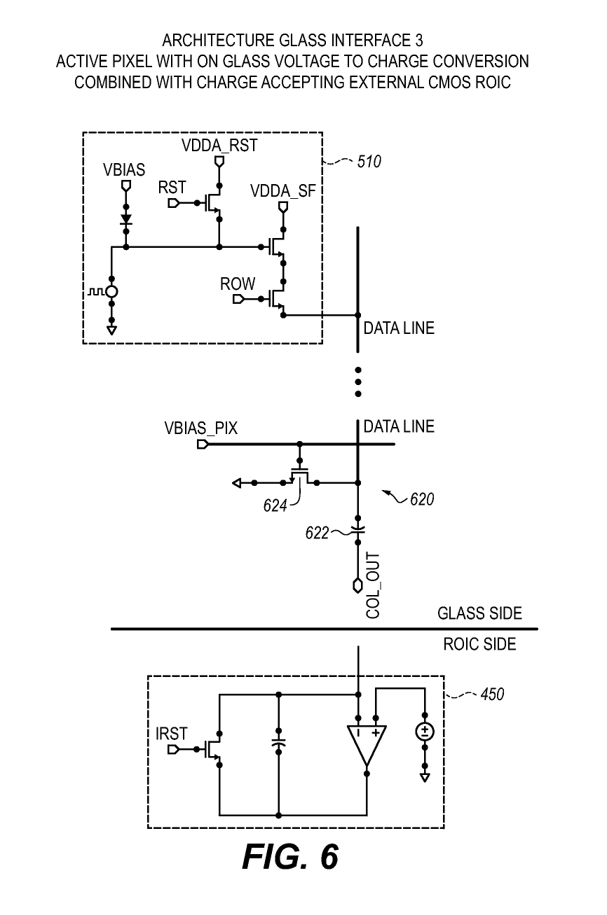

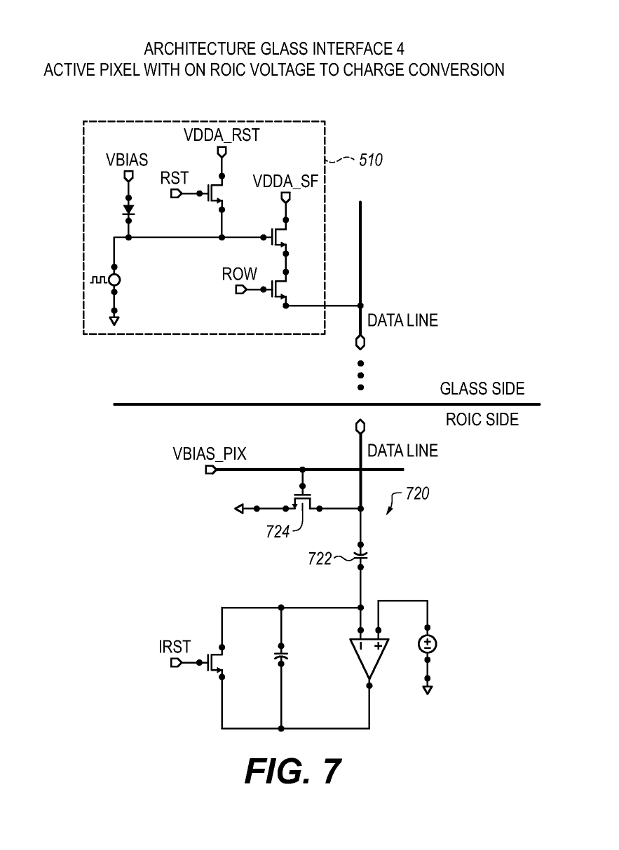

FIGS. 6-7 are diagrams that show an imaging array with glass side active pixels, but in addition each can have a capacitive element per column that can translate voltage into charge (e.g., charge conversion circuitry) according to the application. Existing ROIC designs can be utilized with the embodiments shown in FIG. 6 as described below.

An exemplary difference between FIGS. 6 and 7 relates to a pixel bias element and a capacitor element with respect to physical location. FIG. 6 designs these elements on glass, and accordingly, no new ROIC design is used. FIG. 7 designs these elements on the ROIC side, which can require a new design. One advantage of FIG. 7 can be lower mismatching of pixel bias current and capacitors that can result is reduced offset and/or gain fixed pattern noises

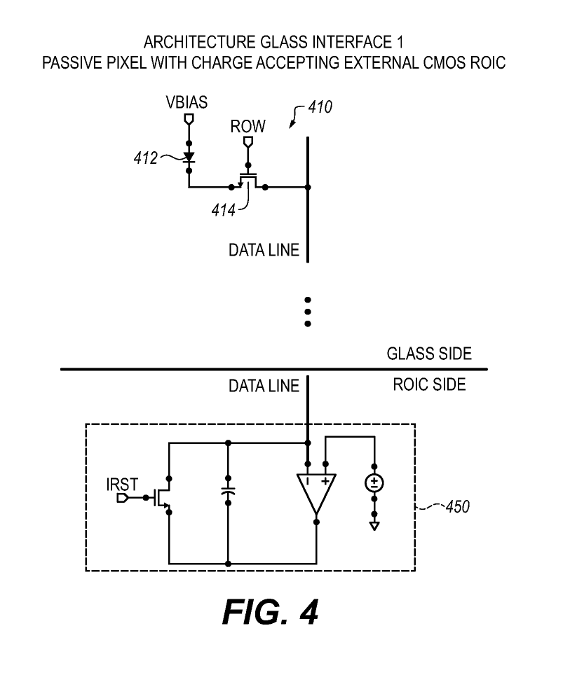

FIG. 4 shows a related art radiographic detector with a passive pixel design with charge input ROIC that is currently used. As shown in FIG. 4, a passive a-Si row select TFT 414 and PIN diode 412 represents a unit pixel cell 410. The glass interfaces to a charge accepting ROIC 450 that is commercially available today.

FIG. 5 is a diagram that shows an exemplary embodiment that can combine an active pixel design and a new novel ROIC architecture/design. As shown in FIG. 5, a pixel 510 design is an exemplary 3 transistor (T) pixel. Embodiments of a new ROIC design would require a capability/modification to accept a voltage input. This is not currently done in industry. IN one embodiment, shown in FIG. 5, a pixel bias transistor 552 can be implemented in a ROIC 550 configured to accept a voltage input. The physical location of the pixel bias transistor can be implemented at, but is not limited to the ROIC side rather than the glass side for matching as shown in FIG. 5.

There is no current ROIC commercially available for a radiographic area detector that allows for voltage input, only charge as an input. Certain exemplary embodiments according to the application can use an architecture that uses the ROIC 550 that can accept voltage input. The ROIC 550 internal design as shown in the FIG. 5 diagram is configured differently than traditional charge ROICs. For example, standard low voltage CMOS processes/manufacturing/circuits used for ROICs would not be able to handle the voltages output by the radiographic imaging array (e.g., 10 volts).

Active pixel implementations herein are not intended to be limited to 3T pixels but also alternative pixels such as 4T pixels. In one embodiment, active pixel embodiments can use amorphous indium-gallium-zinc-oxide (IGZO) materials and/or IGZO process technology. In one embodiment, active pixel embodiments can use a-Si materials and/or a-Si process technology.

FIG. 6 is a diagram that shows a schematic of a portion of a radiographic imaging array including an exemplary active pixel with voltage to charge conversion implemented on glass and charge input ROIC embodiment according to the application. As shown in FIG. 6, this exemplary radiographic imaging array embodiment can contain the same pixel 510 architecture as FIG. 5, a typical 3T pixel. This exemplary radiographic imaging array embodiment can also contain the same ROIC architecture as FIG. 4, a typical charge input ROIC which is available today. As shown in FIG. 6, one difference relative to the related art is an added per column Voltage to charge (V to Q) conversion capacitor (e.g., charge conversion circuitry). As shown in FIG. 6, an added per column voltage to charge (V to Q) conversion 620 can include a capacitor 622 and a bias transistor 624. As known to one skilled in the art, specific implementations of the voltage to charge (V to Q) conversion 620 can be based on a corresponding pixel and/or ROIC configuration in radiographic flat panel detectors.

An active pixel structure including 3 or more TFT elements along with a biasing TFT element can output a voltage onto conductive data lines. A typical 3T active pixel structure can output a signal voltage first, which is proportional to the light accumulated onto the photo-detector element. A 3T active pixel structure can then output a reset voltage second as a function of enabling the reset transistor element within an active pixel structure. The voltage difference can be translated to a charge difference by using a voltage to charge element between the active pixel structure and a charge input accepting ROIC structure. This charge difference can be sensed by a charge input accepting ROIC for further conditioning.

When implementing various embodiment integrations on silicon chip and glass, all of the necessary components are desired to be on the glass, which includes the column circuit, buffers and ADC. In the case of CMOS technology, the device characteristics are so good that this makes sense and is fully realizable. However even though a-IGZO is better than a-Si in its device characteristics, it is still no match for CMOS. Maintaining CMOS readout data rate speeds is unlikely and full a-IGZO ADC on glass is also unlikely.

Certain exemplary embodiments described herein include an interface on glass that can change voltage to charge (V to Q) to provide an active pixel on glass for low noise and/or maintain the high readout performance using external ROICs. These exemplary embodiments using column circuit implementation on glass can provide better imaging array performance.

Note that in one embodiment, the column circuit design is not a switched capacitor in nature that can be what typical architectures use. No switches are required for the voltage to charge conversion embodiment as shown in FIG. 6, which can help to limit/reduce the design complexity in both support higher voltage switching elements and/or noise artifacts associated with high voltage and higher speed clocking. Having this column circuit capacitor embodiment, voltage to charge conversion allows the use of existing ROIC technology and focus on active pixel architectures using IGZO (e.g., IGZO TFTs). Such exemplary embodiments using the voltage to charge interface on glass can provide better imaging array performance and claimed herein.

FIG. 7 is a diagram that shows a exemplary embodiment that can combine an active pixel design and a new novel ROIC architecture/design. As shown in FIG. 7, this embodiment is similar to the embodiment shown in FIG. 6 but the pixel bias element and the V to Q capacitor are on the ROIC side, rather than the glass side. The embodiment shown in FIG. 7 would require a new ROIC design that does not exist today. As shown in FIG. 7, an added per column voltage to charge (V to Q) conversion 720 can include a V to Q capacitor 722 and a bias transistor 724. As shown in FIG. 7, an added per column voltage to charge (V to Q) conversion 720 can be implemented on the ROIC side (off the glass) but not in the ROIC itself (e.g., as a separate circuit or on the flex circuit 218). As known to one skilled in the art, specific implementations of the voltage to charge (V to Q) conversion 620 can be based on a corresponding pixel and/or ROIC configuration in radiographic flat panel detectors.

Benefits of the embodiment of FIG. 7 can include reducing the potential for transistor mismatch of the pixel bias TFT and the capacitor mismatch of the V to Q capacitor.

Active pixel implementations herein are not intended to be limited to 3T pixels but also alternative pixels such as 4T pixels. In one embodiment, active pixel embodiments can use IGZO materials and/or IGZO process technology. In one embodiment, active pixel embodiments can use a-Si materials and/or a-Si process technology. In one embodiment, adding switches for multiple capacitors (e.g., changing the size, with various sizes) can allow for increasing an allowable gain range. In one embodiment, alternative designs can use switches for binning implementation (e.g., horizontal).

Exemplary embodiments according to the application occur at/nearby the sensor (e.g., a-Si, a-IGZO) on glass interface to the ROICs (e.g., formed in crystal silicon that are damaged by X-rays). Generally, ROICs are positioned to the side (outside the imaging area) or underneath the imaging array and protected by a lead shield.

In certain exemplary embodiments, digital radiographic imaging detectors can include thin-film elements such as but not limited to thin-film photosensors and thin-film transistors. Thin film circuits can be fabricated from deposited thin films on insulating substrates as known to one skilled in the art of radiographic imaging. Exemplary thin-film circuits can include a-IGZO devices such as a-IGZO TFTs or PIN diodes, Schottky diodes, MIS photocapacitors, and be implemented using amorphous semiconductor materials, polycrystalline semiconductor materials such as metal oxide semiconductors. Certain exemplary embodiments herein can be applied to digital radiographic imaging arrays where switching elements include thin-film devices including at least one semiconductor layer. Certain exemplary embodiments herein can be applied to digital radiographic imaging arrays where the DR detector is a flat panel detector, a curved detector or a detector including a flexible imaging substrate.

Certain exemplary embodiments herein can be applied to digital radiographic imaging arrays where photoelectric conversion elements include at least one semiconductor layer, and that at least one semiconducting layer can include amorphous silicon, micro-crystalline silicon, poly-crystalline silicon, single-crystal silicon-on-glass (SiOG), organic semiconductor, and metal oxide semiconductors. Certain exemplary embodiments herein can be applied to digital radiographic imaging arrays where switching elements include at least one semiconductor layer, and that at least one semiconducting layer can include amorphous silicon, micro-crystalline silicon, poly-crystalline silicon, single-crystal silicon-on-glass (SiOG), organic semiconductor, and metal oxide semiconductors.

The present application contemplates methods and program products on any computer readable media for accomplishing its operations. Exemplary embodiments according to the present application can be implemented using an existing computer processor, or by a special purpose computer processor incorporated for this or another purpose or by a hardwired system.

Also known in the art are digital radiographic imaging panels that utilize an array of pixels comprising an X-ray absorbing photoconductor, such as amorphous Selenium (a-Se), and a readout circuit. Since the X-rays are absorbed in the photoconductor, no separate scintillating screen is required.

It should be noted that while the present description and examples are primarily directed to radiographic medical imaging of a human or other subject, embodiments of apparatus and methods of the present application can also be applied to other radiographic imaging applications. This includes applications such as non-destructive testing (NDT), for which radiographic images may be obtained and provided with different processing treatments in order to accentuate different features of the imaged subject.

Priority is claimed from commonly assigned, copending U.S. Provisional Patent Application Ser. No. 61/790,618 filed Mar. 15, 2013 in the name of Ravi K MRUTHYUNJAYA et al., titled RADIOGRAPHIC DETECTOR USING POLYCRYSTALLINE ACTIVE PIXEL ARCHITECTURE USING VOLTAGE TO CHARGE CONVERSION ON GLASS, the contents of which are incorporated fully herein by reference.

As will be appreciated by one skilled in the art, the present invention may be embodied as a system, method, or computer program product. Accordingly, an embodiment of the present invention may be in the form of an entirely hardware embodiment, an entirely software embodiment (including firmware, resident software, micro-code, and other suitable encodings) or an embodiment combining software and hardware aspects that may all generally be referred to herein as a “circuit” or “system.” Furthermore, the present invention may take the form of a computer program product embodied in a computer-readable storage medium, with instructions executed by one or more computers or host processors. This medium may comprise, for example: magnetic storage media such as a magnetic disk (such as a hard drive or a floppy disk) or magnetic tape; optical storage media such as an optical disc, optical tape, or machine readable bar code; solid state electronic storage devices such as solid state hard drives, random access memory (RAM), or read only memory (ROM); or any other physical device or medium employed to store a computer program. The computer program for performing the method of the present invention may also be stored on computer readable storage medium that is connected to a host processor by way of the internet or other communication medium.

Those skilled in the art will readily recognize that the equivalent of such a computer program product may also be constructed in hardware. The computer-usable or computer-readable medium could even be paper or another suitable medium upon which executable instructions are printed, as the instructions can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport computer instructions for use by, or in connection with, an instruction execution system, apparatus, or device.

In accordance with one embodiment of the application, a digital radiographic area detector can include an imaging array including a plurality of active pixels, each active pixel comprising at least one amorphous IGZO electrically chargeable photosensor and at least three thin-film transistors; a bias control circuit to provide a bias voltage to the photosensors for a portion of the imaging array; first conductive lines coupled to a plurality of active pixels arranged along a first direction in the portion of the imaging array; second conductive lines coupled to a plurality of active pixels arranged along a second direction in the portion of the imaging array; circuits to provide signal sensing for the portion of the imaging array coupled to the second conductive lines; and charge conversion circuitry to convert voltage values output by the active pixels to a corresponding charge values for input to the signal sensing circuits during readout of a signal from the portion of the imaging array.

In accordance with one embodiment of the application, a digital radiographic area detector can include an imaging array including a plurality of active pixels, each active pixel including at least one amorphous silicon/a-IGZO electrically chargeable photosensor and at least three thin-film transistors; circuits to provide signal sensing for the portion of the imaging array coupled to conductive data lines; and charge conversion circuitry to convert voltage values output by the active pixels to a corresponding charge values for input to the signal sensing circuits during readout of a signal from a portion of the imaging array, where the active pixels are configured to output voltage on second conductive lines and the charge conversion circuitry comprises a first circuit formed in crystal silicon at ROICs formed in crystal silicon to convert the signal sensing circuits to accept voltage. In one embodiment, the ROICs are configured to input the voltage as input signals to output corresponding digital data. In one embodiment, the imaging array includes a-IGZO devices.

While the invention has been illustrated with respect to one or more implementations, alterations and/or modifications can be made to the illustrated examples without departing from the spirit and scope of the appended claims. In addition, while a particular feature of the invention can have been disclosed with respect to only one of several implementations, such feature can be combined with one or more other features of the other implementations as can be desired and advantageous for any given or particular function. The term “at least one of” is used to mean one or more of the listed items can be selected. The term “about” indicates that the value listed can be somewhat altered, as long as the alteration does not result in nonconformance of the process or structure to the illustrated embodiment. Finally, “exemplary” indicates the description is used as an example, rather than implying that it is an ideal. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A digital radiographic area detector comprising:
an imaging array comprising a plurality of active pixels, each active pixel comprising at least one amorphous silicon electrically chargeable photosensor and at least three thin-film transistors;
a bias control circuit to provide a bias voltage to the photosensors for a portion of the imaging array;
first conductive lines coupled to a plurality of active pixels arranged along a first direction in the portion of the imaging array;
second conductive lines coupled to a plurality of active pixels arranged along a second direction in the portion of the imaging array;
circuits to provide signal sensing for the portion of the imaging array coupled to the second conductive lines; and
charge conversion circuitry to convert voltage values output by the active pixels to a corresponding charge values for input to the signal sensing circuits during readout of a signal from the portion of the imaging array.

2. The digital radiographic detector of claim 1, where the active pixels are configured to output voltage on second conductive lines and the charge conversion circuitry comprises a first circuit formed in crystal silicon at ROICs formed in crystal silicon to convert the signal sensing circuits to accept voltage.

3. The digital radiographic detector of claim 1, where the active pixels are configured to output voltage on the second conductive lines and the charge conversion circuitry comprises first circuit to convert voltage to charge, and where the signal sensing circuits comprises ROICs formed in crystal silicon that input charge values.

4. The digital radiographic detector of claim 1, where the active pixels are configured to output voltage on the second conductive lines and the charge conversion circuitry comprises first circuit to convert voltage to charge, where the first circuit is formed of amorphous silicon on the imaging array.

5. The digital radiographic detector of claim 1, where the active pixels are configured to output voltage on the second conductive lines and the charge conversion circuitry comprises first circuit to convert voltage to charge, where the first circuit is formed of amorphous silicon between the imaging array and the signal sensing circuits.

6. The digital radiographic detector of claim 1, where the active pixels are configured to output voltage on the second conductive lines and the charge conversion circuitry comprises first circuit to convert voltage to charge, where the first circuit is formed of polycrystalline semiconductor materials at the imaging array.

7. The digital radiographic detector of claim 1, where the signal sensing circuits comprises ROICs formed in crystal silicon.

8. The digital radiographic detector of claim 1, wherein the photosensors comprise MIS photosensor or a PIN photodiodes, wherein the imaging array comprises a-IGZO devices, and wherein the DR detector is a flat panel detector, a curved detector or a detector including a flexible imaging substrate.

9. The digital radiographic detector of claim 1, further comprising:
a scintillator screen disposed on a side of the detector array for converting a radiographic image into a radiographic light image that is converted by the detector array into the electronic radiographic image;
a stiffener disposed in the cavity;
a shock absorbing assembly comprising an elastomeric material and located within the cavity for absorbing shock to the detector array/stiffener in directions perpendicular to and parallel to the detector array/stiffener;
a wireless interface having an antenna for wirelessly transmitting an electronic radiographic image from the detector to a remote location; and
a battery and imaging electronics mounted within the cavity below the detector array/stiffener.

10. A digital radiographic area detector comprising:
an imaging array comprising a plurality of active pixels, each active pixel comprising at least one polycrystalline semiconductor electrically chargeable photosensor and thin-film transistors;
first conductive lines (e.g., datalines) coupled to a plurality of active pixels arranged along a first direction in the portion of the imaging array;
circuits to provide signal sensing for the portion of the imaging array coupled to the second conductive lines; and
charge conversion circuitry to convert voltage values output by the active pixels to a corresponding charge values for input to the signal sensing circuits.

11. A method of operating a digital radiographic area detector comprising an imaging array comprising a plurality of active pixels, each active pixel comprising at least one polycrystalline semiconductor electrically chargeable photosensor and at least three thin-film transistors, the method comprising:
outputting voltage values corresponding to an x-ray exposure by at least one active pixel;
converting the output voltage values to corresponding charge values;
receiving the corresponding charge values at signal sensing circuits;
and
converting the corresponding charge values to digital values.
